(19) United States
(12) Patent Application Publication
(10) Pub. No.: US 2008/0259310 A1
(43) Pub. Date: Oct. 23, 2008

(54) OPTICAL POSITION DETECTION DEVICE AND ELECTRONIC EQUIPMENT

(76) Inventor: Hideo WADA, Katsuragi-shi (JP)

Correspondence Address: BIRCH STEWART KOLASCH & BIRCH, PO BOX 747, FALLS CHURCH, VA, 22040-0747, US

(21) Appl. No.: 12/105,043

(22) Filed: Apr. 17, 2008

(30) Foreign Application Priority Data
Apr. 18, 2007 (JP) 2007-109219

(51) Int. Cl. G01C 3/08

(52) U.S. Cl. 356/3.11

(57) ABSTRACT

An optical position detection device capable of detecting a position of a light source with high accuracy and being low priced is provided. A transmission system 1 detects a position of the transmission system 1 relative to a reception system 2 based on a fixed distance L between a second light source 12 and a third light source 13, an incoming angle θ₂ of signal light R2 from the second light source 12 relative to the transmission system 1, and an incoming angle θ₃ of signal light R3 from the third light source 13 relative to the transmission system 1.

This nonprovisional application claims priority under 35 U.S.C. §119(a) on Patent Application No. 2007-109219 filed in Japan on Apr. 18, 2007, the entire contents of which are hereby incorporated by reference.

### BACKGROUND OF THE INVENTION

The present invention relates to a detection device for specifically determining a position from which light is emitted and, more specifically, to an optical position detection device for determining a position of a remote controller by using signal light emitted from the remote controller.

The invention also relates to electronic equipment, such as air conditioners, video equipment, acoustic equipment and cameras, having the optical position detection device.

Conventionally, there have been proposed various optical angle detection devices for detecting a position of a light source of a remote controller or the like. Its light-receiving portion is commonly so designed that with two photodiodes placed adjacent to each other or with a PSD (Position Sensitive Device) used, a light-shielding member is properly positioned above the light-receiving surfaces so as to allow a difference between two output terminals to be detected by a shadow formed by the light-shielding member depending on an incident angle of light, that is, the principle of sundial is adopted.

For example, in a first prior art example (JP 8-264826 A), above light-receiving surfaces of two photodiodes are provided light-shielding regions which measure half their light-receiving areas, respectively, so that an incident angle of light is detected by computing an output ratio of the two light-receiving element.

Similarly, in a second prior art example (JP 8-340124 A), a light-receiving portion having an aperture for an incoming direction of light is provided so that an incident angle of light is detected by computing an output ratio of the two photodiodes.

There have been large numbers of applications using such optical angle detection devices as described above to control the orientation direction of equipment toward a transmission operator of the remote controller.

However, these prior art examples are only to detect the direction of a light source, and incapable of detecting a position of the transmission operator including the distance thereto.

In a third prior art example (JP 4-322208 A), with two ultrasonic receivers and a photodetector placed at positions that are distant from each other by a fixed spacing, a distance between the two ultrasonic receivers and a transmitter is detected from an arrival time difference between a light wave and an acoustic wave to thereby detect the direction of the transmitter (light source).

This third prior art example is applied only for specifically determining the incoming direction of light. However, since the fixed spacing between the two ultrasonic receivers is in general small enough, compared with the distances between the two ultrasonic receivers and the transmitter, it can be easily inferred by analogy that an approximate position of the transmission operator can be specifically determined from the incoming direction of light and the distances between the two ultrasonic receivers and the transmitter.

Further, in consideration of combinations of the first to third prior art examples, the position of the transmission operator can be detected in the following manner. With optical angle detection devices of either the first or the second prior art example used at positions of the two ultrasonic receivers in the third prior art example, if the position of the transmitter is the position of the light source, then incident angles on the two receivers are detected, where because the distance between the receivers is known, a triangle formed by the transmitter and the two receivers is uniquely determined. Thus, the position of the transmitter (light source) can be specifically determined.

Nevertheless, this optical position detection device of the prior arts, to improve the position detection accuracy, needs to improve the detected angle accuracy of the optical angle detection device or the detection accuracy for the arrival time difference between light wave and acoustic wave, or to enlarge the fixed spacing between the two receivers.

The former means, improving the detection device accuracy, is the easiest, but would inevitably cause the device price to be increased.

The latter means, increasing the fixed spacing between the receivers, would involve light intensities (analog signals) that represent signals detected by the two receivers. Therefore, in order to compute the ratio of signal quantities detected by the two receivers, there arises a need for long-distance analog signal transmission, or a need for converting the analog signals to digital signals by using A/D converters for the receivers before transmitting the signals to a computing unit that computes the ratio.

Transmission of analog signals would involve another problem that the larger the transmission distance is, the larger the noise component superimposed on the signal line is, resulting in deteriorations of the detection accuracy. Also, providing the receivers with the A/D converters, respectively, would lead to higher prices of the position detector. Further, due to quite weak strengths of signals detected by the receivers, those signals need to be amplified in the vicinities of the receivers, making it necessary to provide signal processing circuits in a number corresponding to the number of receivers. This further necessitates long-distance wiring of the power supply system for the signal processing circuits as well.

In the position detection method by the third prior art example, there is a problem that two transmission systems and reception systems for light wave and acoustic wave, causing the device to be further higher priced, besides those issues described above.

### SUMMARY OF THE INVENTION

Accordingly, an object of the present invention is to provide an optical position detection device which is capable of accurately detecting the position of a light source and lower in price.

In order to achieve the above object, according to the present invention, there is provided an optical position detection device comprising:

a detection system having an optical angle sensor for detecting an incoming angle of light; and

a reference system having two light sources placed so as to be spaced from each other with a fixed distance, wherein

the optical angle sensor receives signal light from each of the two light sources to detect an incoming angle of the signal light from one of the light sources relative to the detection system as well as an incoming angle of the signal light from the other of the light sources relative to the detection system, and

the detection system detects a position of the detection system relative to the reference system based on the fixed distance between the two light sources, the incoming angle of the signal light from the one of the light sources relative to the detection system, and the incoming angle of the signal light from the other of the light sources relative to the detection system.

In this optical position detection device, since the detection system detects a position of the detection system relative to the reference system based on the fixed distance between the two light sources, an incoming angle of the signal light from the one of the light sources relative to the detection system, and an incoming angle of the signal light from the other of the light sources relative to the detection system, there is neither a need for making long-distance transmission of analog signal quantities having optical angle information nor a need for including a plurality of A/D converters, as would be involved in the prior arts, thus making it possible to provide a high-accuracy optical position detection device with a low price.

According to the invention, there is also provided an optical position detection device comprising:

a transmission system having a first light source for emitting remote control signal light, and an optical angle sensor for detecting an incoming angle of light;

a reception system having a remote control light-receiving unit for receiving the remote control signal light from the first light source, and a second light source and a third light source placed so as to be spaced from each other with a fixed distance, wherein

the optical angle sensor receives signal lights from the second light source and the third light source to detect an incoming angle of the signal light from the second light source relative to the transmission system, and an incoming angle of the signal light from the third light source relative to the transmission system, and

the transmission system detects a position of the transmission system relative to the reception system based on the fixed distance between the second light source and the third light source, the incoming angle of the signal light from the second light source relative to the transmission system, and the incoming angle of the signal light from the third light source relative to the transmission system.

In this optical position detection device, since the transmission system detects the position of the transmission system relative to the reception system based on the fixed distance between the second light source and the third light source, the incoming angle of the signal light from the second light source relative to the transmission system, and the incoming angle of the signal light from the third light source relative to the transmission system, there is neither a need for making long-distance transmission of analog signal quantities having optical angle information nor a need for including a plurality of A/D converters, as would be involved in the prior arts, thus making it possible to provide a high-accuracy optical position detection device with a low price.

In one embodiment, the reception system receives the remote control signal light derived from the first light source on the remote control light-receiving unit, and thereafter emits the signal lights from the second light source and the third light source.

In this embodiment, since the reception system receives the remote control signal light derived from the first light source on the remote control light-receiving unit, and thereafter emits signal light from the second light source and the third light source, there is no need for emitting the signal light constantly or at specified intervals from the second light source and the third light source, so that the position of the transmission system can be detected by emitting the remote control signal light at the time whenever it is desired to detect the position of the transmission system (transmission operator). Thus, efficient control of the device becomes achievable.

In one embodiment, the reception system emits the signal light from the second light source, and thereafter emits the signal light from the third light source.

In this embodiment, since the reception system emits signal light from the second light source, and thereafter emits signal light from the third light source, the optical angle sensor of the transmission system detects the signal light of the second light source and the signal light of the third light source sequentially, so that the optical angle sensor can achieve angle detections by one sensor itself. Thus, the device can be made up with a low price.

In one embodiment, the transmission system and the reception system are straightly confronted by each other.

In this embodiment, since the transmission system and the reception system are straightly confronted by each other, the angles of the transmission system and the reception system are fixed, so that the detection accuracy of the transmission system can be improved.

In one embodiment, the transmission system detects a light intensity of signal light derived from the second light source and a light intensity of signal light derived from the third light source to detect a ratio of the light intensity of signal light from the second light source to the light intensity of signal light from the third light source.

In this embodiment, since the transmission system detects the light intensity of signal light derived from the second light source and the light intensity of signal light derived from the third light source to detect the ratio of the light intensity of signal light from the second light source to the light intensity of signal light from the third light source, the positional information as to the transmission system is supplemented with the light intensity ratio, so that the position of the transmission system can be detected with high accuracy.

In one embodiment, at least one of the second light source and the third light source has a function of adjusting light emission quantity.

In this embodiment, at least either one of the second light source and the third light source has a function of adjusting light emission quantity. Therefore, when the light emission quantities of the second light source and the third light source are controlled so that the signal light of the second light source and the signal light of the third light source to be detected by the optical angle sensor become constant quantities, it becomes possible to give a supplementation to the positional information as to the transmission system, making it possible to detect the position of the transmission system with high accuracy.

In one embodiment, the reception system has a fourth light source, and

the optical angle sensor receives signal light from the fourth light source to detect an incoming angle of the signal light from the fourth light source relative to the transmission system.

In this embodiment, since the optical angle sensor receives the signal light from the fourth light source to detect an incoming angle of the signal light from the fourth light source relative to the transmission system, the positional information as to the transmission system is supplemented with the incoming angle of the signal light from the fourth light source relative to the transmission system, making it achievable to detect the position of the transmission system with high accuracy.

In one embodiment, the reception system receives the remote control signal light derived from the first light source on the remote control light-receiving unit, and thereafter emits signal lights from the second light source, the third light source and the fourth light source.

In this embodiment, since the reception system receives the remote control signal light derived from the first light source on the remote control light-receiving unit, and thereafter emits the signal lights from the second light source, the third light source and the fourth light source, there is no need for emitting the signal lights constantly or at specified intervals from the second light source, the third light source and the fourth light source, so that the position of the transmission system can be detected by emitting the remote control signal light at the time whenever it is desired to detect the position of the transmission system (transmission operator). Thus, efficient control of the device becomes achievable.

In one embodiment, the reception system emits signal light from the second light source, emits signal light from the third light source, and emits signal light from the fourth light source, sequentially.

In this embodiment, since the reception system emits signal light from the second light source, emits signal light from the third light source, and emits signal light from the fourth light source, sequentially, the optical angle sensor of the transmission system detects the signal light of the second light source, the signal light of the third light source and the signal light of the fourth light source sequentially, so that the optical angle sensor can achieve angle detections by one sensor itself. Thus, the device can be made up with a low price.

In one embodiment, the optical angle sensor, the second light source and the third light source are placed on an xz plane, and

the second light source and the third light source are placed on an x axis.

In this embodiment, the optical angle sensor, the second light source and the third light source are placed on the xz plane, and the second light source and the third light source are placed on the x axis. Therefore, it becomes achievable to detect the position of the transmission system with high accuracy.

In one embodiment, the optical angle sensor, the second light source, the third light source and the fourth light source are placed on an xz plane, and

the second light source, the third light source and the fourth light source are placed on an x axis.

In this embodiment, since the optical angle sensor, the second light source, the third light source and the fourth light source are placed on the xz plane, and the second light source, the third light source and the fourth light source are placed on the x axis. Therefore, it becomes achievable to detect the position of the transmission system with high accuracy.

In one embodiment, the second light source, the third light source and the fourth light source are placed on the x axis at equal intervals.

In this embodiment, since the second light source, the third light source and the fourth light source are placed on the x axis at equal intervals, signal-light detection accuracies of the second light source, the third light source and the fourth light source become equivalent to one another, making it possible to achieve a stable, high-accuracy position detection of the transmission system.

In one embodiment, the optical angle sensor is a sensor capable of detecting two-dimensional angles, and

the second light source, the third light source and the fourth light source are placed on an xy plane.

In this embodiment, the optical angle sensor is a sensor capable of detecting two-dimensional angles, and the second light source, the third light source and the fourth light source are placed on the xy plane. Therefore, it becomes achievable to detect three-dimensional positions within the space of the transmission system.

In one embodiment, signal light of the second light source and signal light of the third light source are modulated so that their modulation frequencies become different from one another.

In this embodiment, since the signal light of the second light source and the signal light of the third light source are modulated so that their modulation frequencies become different from one another, providing signal processing circuits having filter circuits for the modulation frequencies of the individual light sources in the optical angle sensor allows signals from the individual light sources to be separated from each other, so that simultaneous detection of optical angles becomes achievable. Thus, the measuring time can be shortened.

In one embodiment, signal light of the second light source, signal light of the third light source and signal light of the fourth light source are modulated so that their modulation frequencies become different from one another.

In this embodiment, the signal light of the second light source, the signal light of the third light source and the signal light of the fourth light source are modulated so that their modulation frequencies become different from one another, providing signal processing circuits having filter circuits for the modulation frequencies of the individual light sources in the optical angle sensor allows signals from the individual light sources to be separated from one another, so that simultaneous detection of optical angles becomes achievable. Thus, the measuring time can be shortened.

Electronic equipment of this invention has any one of optical position detection devices as described above.

According to this electronic equipment, which has the optical position detection device, controlling the operation of the electronic equipment by the optical position detection device makes it possible to expand the application scope of the way how various types of electronic equipment are used.

In the case where the electronic equipment is an air conditioner as an example, detecting a position of the remote control transmitter allows the air conditioner to perform control for indoor temperatures optimized to the position of the remote control transmitter. This makes it possible not only to provide a comfort living space but also to eliminate the need for air-conditioning wasteful spaces, by which energy saving becomes also achievable.

According to the optical position detection device of the invention, since the detection system detects a position of the detection system relative to the reference system based on the fixed distance between the two light sources, an incoming angle of signal light from the one of the light sources relative to the detection system, and an incoming angle of signal light from the other of the light sources relative to the detection system, it becomes possible to provide a high-accuracy optical position detection device with a low price.

According to the optical position detection device of the invention, since the transmission system detects a position of the transmission system relative to the reception system based on the fixed distance between the second light source and the third light source, an incoming angle of signal light from the second light source relative to the transmission system, and an incoming angle of signal light from the third light source relative to the transmission system, it becomes possible to provide a high-accuracy optical position detection device with a low price.

According to the electronic equipment of the invention, since the electronic equipment has the optical position detection device, controlling the operation of the electronic equipment by the optical position detection device makes it possible to expand the application scope of the way how various types of electronic equipment are used.

### BRIEF DESCRIPTION OF THE DRAWINGS

The present invention will become more fully understood from the detailed description given hereinbelow and the accompanying drawings which are given by way of illustration only, and thus are not intended to limit the present invention, and wherein:

FIG. 1 is a simplified constructional view showing a first embodiment of an optical position detection device of the invention;

FIG. 2 is an explanatory view showing a coordinate system of the optical position detection device of FIG. 1;

FIG. 3 is a simplified constructional view showing another construction of the optical position detection device;

FIG. 4 is an explanatory view showing a coordinate system of the optical position detection device of FIG. 3;

FIG. 5 is an explanatory view showing a second embodiment of an optical position detection device of the invention as well as a coordinate system therefor;

FIG. 6 is an explanatory view showing a third embodiment of the optical position detection device of the invention as well as a coordinate system therefor;

FIG. 7 is an explanatory view for explaining a two-dimensional optical angle sensor;

FIG. 8 is a simplified constructional view showing a structure of the two-dimensional optical angle sensor;

FIG. 9 is a projection chart of the optical position detection device of FIG. 6 on the yz plane; and

FIG. 10 is a simplified constructional view showing a fourth embodiment of an optical position detection device of the invention.

### DETAILED DESCRIPTION OF THE INVENTION

Hereinbelow, the present invention will be described in detail by way of embodiments thereof illustrated in the accompanying drawings.

### First Embodiment

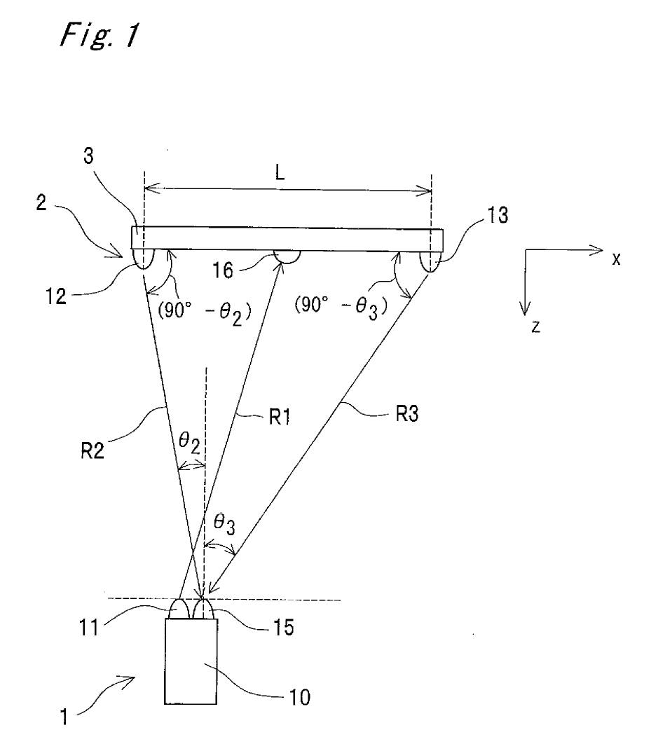

FIG. 1 shows a simplified constructional view which is a first embodiment of the optical position detection device of the invention. This optical position detection device has a transmission system 1 and a reception system 2. In FIG. 1, on the assumption that the drawing sheet is an xz plane, the transmission system 1 and the reception system 2 are placed on the xz plane.

The transmission system 1 has a remote control transmitter 10, a first light source 11 and an optical angle sensor 15. The reception system 2 has a remote control light-receiving unit 16, a second light source 12 and a third light source 13. The optical angle sensor 15, the second light source 12 and the third light source 13 are placed on the xz plane.

The first light source 11, the second light source 12 and the third light source 13 have LEDs and lens systems for making output light pencils of their LEDs directed toward desired directivities, respectively. The second light source 12 and the third light source 13 are placed on the x axis so as to be spaced from each other with a fixed distance L.

The optical angle sensor 15 is a sensor for detecting an incoming angle of light, exemplified by a light-receiving element shown in the prior arts. A center axis (optical axis) of the optical angle sensor 15 is placed parallel to the z axis. That is, the transmission system 1 and the reception system 2 are straightly confronted by each other.

The remote control transmitter 10 has a function of giving an appropriate remote control signal light R1 to the first light source 11 to make a remote control signal light R1 emitted from the first light source 11, and moreover computing an incident angle of light detected by the optical angle sensor 15.

The remote control light-receiving unit 16 has a function of receiving the remote control signal light R1 emitted from the first light source 11 to detect a code signal of the remote control signal light R1. The remote control light-receiving unit 16, although positioned between the second light source 12 and the third light source 13, yet has only to be placed at a position that allows the remote control signal light R1 to be received, without any particular limitations.

The optical angle sensor 15 receives signal lights R2, R3 from the second light source 12 and the third light source 13 to detect an incoming angle (first angle θ₂) of the signal light R2 from the second light source 12 relative to the transmission system 1 as well as an incoming angle (second angle θ₃) of the signal light R3 from the third light source 13 relative to the transmission system 1.

The transmission system 1 detects a position of the transmission system 1 relative to the reception system 2 based on the fixed distance L, the first angle θ₂ and the second angle θ₃. That is, the transmission system 1 has a computing section for detecting a position of the transmission system 1 by computations based on the fixed distance L, the first angle θ₂ and the second angle θ₃.

After receiving the remote control signal light R1 from the first light source 11 on the remote control light-receiving unit 16, the reception system 2 emits the signal light R2, R3 from the second light source 12 and the third light source 13.

After emitting the signal light R2 from the second light source 12, the reception system 2 emits the signal light R3 from the third light source 13.

Next, steps for detecting the position of the transmission system 1 is explained.

First, appropriate remote control signal light R1 is outputted from the first light source 11 of the transmission system 1. The remote control light-receiving unit 16 detects the remote control signal light R1 and causes the second light source 12 to output appropriate angle signal light R2.

As shown in FIG. 1, while the reception system 2 and the transmission system 1 are straightly confronted by each other, the angle signal light R2 becomes incident on the transmission system 1 at the first angle θ₂, and the optical angle sensor 15 detects the first angle θ₂. The first angle θ₂ is an angle formed by the angle signal light R2 and the optical axis of the optical angle sensor 15.

Subsequently, the remote control light-receiving unit 16 makes the third light source 13 output appropriate angle signal light R3. As in the case of the angle signal light R2, the optical angle sensor 15 detects an incident angle of the angle signal light R3 to obtain the second angle θ₃. The second angle θ₃ is an angle formed by the angle signal light R3 and the optical axis of the optical angle sensor 15.

In short, the optical position detection method includes a first step for emitting remote control signal light R1 from the first light source 11, a second step for detecting the remote control signal light R1 by the remote control light-receiving unit 16, a third step for emitting angle signal light R2 from the second light source 12 based on the detected remote control signal light R1, a fourth step for detecting the angle signal light R2 by the optical angle sensor 15, a fifth step for emitting angle signal light R3 from the third light source 13 subsequent to the angle signal light R2, and a sixth step for detecting the angle signal light R3 by the optical angle sensor 15.

Since the fixed distance L between the second light source 12 and the third light source 13 is known, the remote control transmitter 10 is enabled to compute its own position from the fixed distance L, the first angle θ₂ and the second angle θ₃.

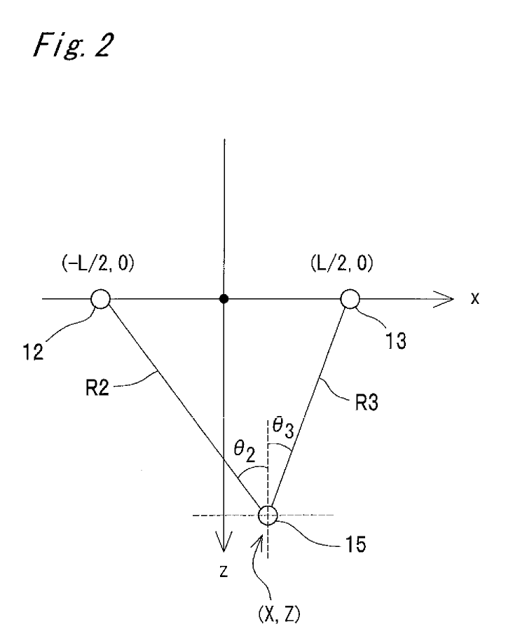

FIG. 2 shows a coordinate relationship of FIG. 1 simplified by setting an origin to a midpoint between the second light source 12 and the third light source 13 for simplicity's sake. From FIG. 2, the position (X, Z) of the remote control transmitter can be determined by the following equations:

$$X = \frac{L}{2} \cdot \frac{tan {θ}_{2} - tan {θ}_{3}}{tan {θ}_{2} + tan {θ}_{3}} \\ Z = L \cdot \frac{1}{tan {θ}_{2} + tan {θ}_{3}} \qquad ( Equation 1 )$$

Although the fixed distance L between the second light source 12 and the third light source 13 needs to be increased for improvement of the position detection accuracy as in the prior art examples, yet in this invention the signal on which the light emission waveform depends is transmitted along a line that connects up to the light source, the signal being an appropriate rectangular wave or sine wave or a DC signal, eliminating the need for long-distance transmission of the analog quantity of a detected angle signal as in the prior art examples and thus enabling high-accuracy position detection. Moreover, since it is light sources such as LEDs that are placed with a spacing of the fixed distance L, there is no need for wiring the power supply line. By contrast, in the prior art examples, since reception systems are placed so as to be spaced from each other with a fixed distance, circuits for signal processing (with power supply required) would be necessitated.

In FIG. 1, the reception system 2 is mounted on an electronic equipment main body 3. That is, the electronic equipment has the optical position detection device. Positional information detected by the transmission system 1 as described above is converted into remote control signal light containing positional information by the transmission system 1, and outputted again from the first light source 11 toward the reception system 2.

The remote control light-receiving unit 16, upon detection of the remote control signal light containing the positional information, controls the electronic equipment main body 3 for a preferable operating state. One example of such cases is that the electronic equipment is a unit of air conditioning equipment such as air conditioner, heating unit or electric fans where it becomes possible to detect a position of the remote controller operator and fulfill an optimum air conditioning toward the position.

Another example is that the electronic equipment is a unit of acoustic equipment such as 5.1-ch surround-sound system, where it becomes possible to detect a position of the remote controller operator and make an optimum sound field.

Yet another example is that the electronic equipment is an imaging device such as camera, where detecting a position of the remote controller operator makes it possible to automatically adjust the direction and focus of the camera, so that the convenience of remote-controller photographing, as would conventionally be performed after the setting of a photographing range and a focus by the photographer, can be greatly improved.

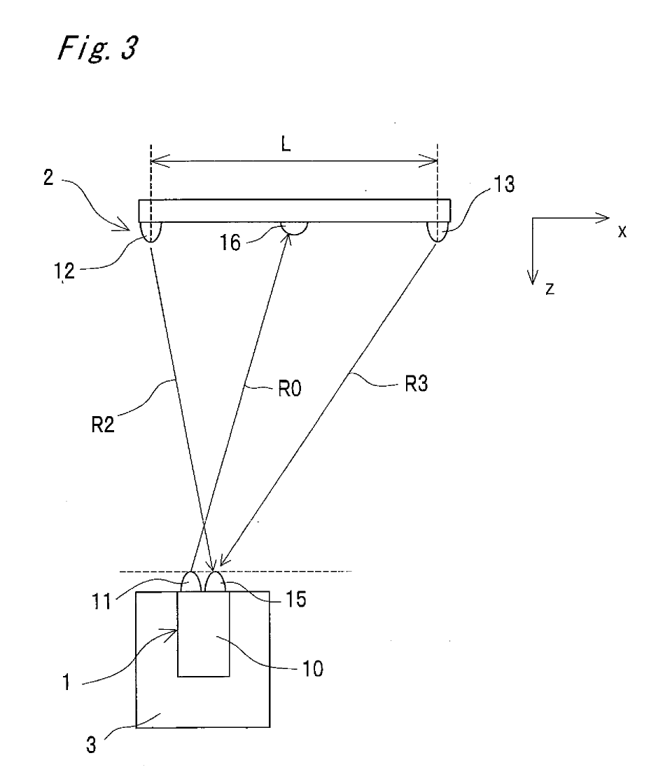

FIG. 3 shows an example in which the transmission system 1 is mounted on the electronic equipment main body 3, in which case the positional information detected as described above is delivered directly to the electronic equipment main body 3 to control its operating state. One example of such cases is that the electronic equipment is a self-propelled robot or an amusement-related robot, where coordinates of the robot's movable range is determined by a reception system installed on a wall or the like, allowing the robot to move about while confirming its own position.

The above-shown examples of electronic equipment are similarly applicable to later-described embodiments and so their explanation is omitted in the description of those embodiments.

In FIG. 1, that the transmission system 1 is straightly confronted by the reception system 2 (i.e., the center axis of the optical angle sensor 15 is parallel to the z axis) is a necessary condition for detecting positional information, whereas the remote controller operator does not necessarily perform the operation in straight confrontation to the reception system 2, which may be a factor of limitation on the scope of use of the remote controller.

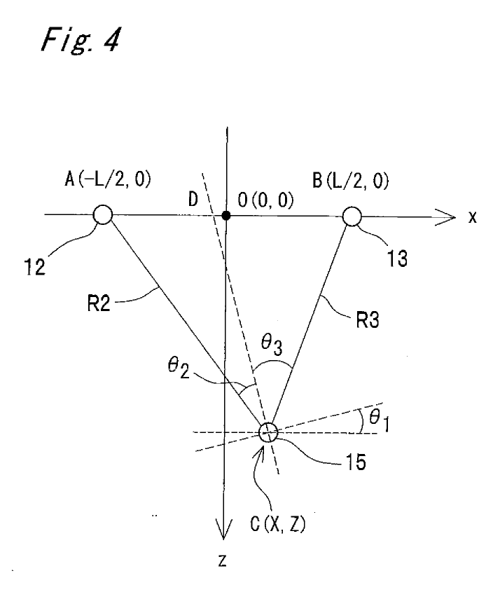

FIG. 4 is a view showing a coordinate system of a state that the transmission system 1 is inclined by an arbitrary angle θ₁. As shown in the figure, the center axis of the optical angle sensor 15 is inclined by the angle θ₁. In brief, in the coordinate system of FIG. 4, the second light source 12 and the third light source 13 are positioned at a point A and point B, respectively, both being on the x axis.

Also, an origin O is set at a midpoint between the point A and the point B, and the optical angle sensor 15 is at a point C. As the center axis of the optical angle sensor 15 is inclined by the angle θ₁ with respect to the reception system 2, a point at which the center axis of the optical angle sensor 15 intersects the x axis is assumed as a point D. Also, an incident angle of a light pencil inputted from the second light source 12 to the optical angle sensor 15 is assumed as an angle θ₂, and an incident angle of a light pencil inputted from the third light source 13 to the optical angle sensor 15 is assumed as an angle θ₃.

Referring to the coordinate system of FIG. 4, it follows that

∠ADC=90°+θ₁

∠BDC=90°−θ₁ (Equation 2)

Therefore, ∠DAC and ∠DBC can be described as follows

∠DAC=90°−θ₁−θ₁

∠DBC=90°−θ₃+θ₁ (Equation 3)

Thus, since the angles expressed by the above equations correspond to gradients of lines, a line AC and a line BC can be expressed by the following equations:

$$Line AC \text{:} z = tan ( 90 ° - {θ}_{2} - {θ}_{1} ) \cdot ( x + \frac{L}{2} ) \\ Line BC \text{:} z = tan ( 90 ° + {θ}_{3} - {θ}_{1} ) \cdot ( x - \frac{L}{2} ) \qquad ( Equation 4 )$$

Since the intersection point of the two equations represents the coordinates of the point C, substituting C(X, Z) into the above equations to calculate X and z yields

$$X = \frac{L}{2} \cdot \frac{tan ( {θ}_{2} + {θ}_{1} ) - tan ( {θ}_{3} - {θ}_{1} )}{tan ( {θ}_{2} + {θ}_{1} ) + tan ( {θ}_{3} - {θ}_{1} )} \\ Z = \frac{L}{tan ( {θ}_{2} + {θ}_{1} ) + tan ( {θ}_{3} - {θ}_{1} )} \qquad ( Equation 5 )$$

As apparent from the above equations, even if both incident angles, the angle θ₂ and the angle θ₃, are detected by the optical angle sensor 15, the position of the transmission system cannot be specifically determined, proving that there is a need for detecting the inclination angle θ₁ of the transmission system.

The inclination angle θ₁ of the transmission system 1 becomes detectable on condition that a ratio of received light intensities from the second light source 12 and the third light source 13 is detected at the detection point C. That is, the transmission system 1 detects a light intensity of signal light R2 derived from the second light source 12 and a light intensity of signal light R3 derived from the third light source 13, and detects a ratio of the light intensity of the signal light R2 derived from the second light source 12 to a light intensity of signal light R3 derived from the third light source 13.

A more detailed description is given below. Given that a line segment AC and a line segment BC have lengths la and lb, respectively, those lengths can be expressed from Pythagorean theorem as

$${la}^{2} = {Z}^{2} + {( X + \frac{L}{2} )}^{2} \\ l {b}^{2} = {Z}^{2} + {( X - \frac{L}{2} )}^{2} \qquad ( Equation 6 )$$

Generally, since light intensity decreases in inverse proportion to the square of the distance. Therefore, given a proportional constant k, a received light intensity Pa from a light source A and a received light intensity Pb from a light source B, the light intensities at the point C are

$$P a = \frac{k}{{la}^{2}} \\ Pb = \frac{k}{l {b}^{2}} \qquad ( Equation 7 )$$

The ratio Pb/Pa of the two received light intensities can be calculated by using Equations 5 to 7 as follows:

$$\begin{matrix}\frac{Pb}{P a} = {( \frac{la}{l b} )}^{2} \\ = \frac{{Z}^{2} + {( X + \frac{L}{2} )}^{2}}{{Z}^{2} + {( X - \frac{L}{2} )}^{2}} \\ = \frac{1 + {tan}^{2} {θ}_{2}}{1 + {tan}^{2} {θ}_{3}} \cdot {( \frac{1 + tan {θ}_{3} \cdot tan {θ}_{1}}{1 - tan {θ}_{2} \cdot tan {θ}_{1}} )}^{2}\end{matrix} \qquad ( Equation 8 )$$

In the above equations, since the ratio (Pb/Pa) of received light intensities and the incident angles (θ₂, θ₃) of the signal lights from the respective light sources are measured values, the inclination θ₁ of the transmission system is the only unknown. Detecting θ₁ from the above equation and applying the result to Equation 5 allows the position (point C) of the transmission system to be detected.

The above description has been shown on a case where received light intensities from the second light source 12 and the third light source 13 are detected in the transmission system 1. However, emitted light intensities of the second light source 12 and the third light source 13 may be controlled so that received light intensities of the second light source 12 and the third light source 13 become equal to each other, or at a constant ratio. Since an emitted light intensity is related to a current intensity acting on a light-emitting element, controlling the quantity of emitted light also allows the inclination angle θ₁ to be detected in the same concept as in Equation 8. At least one of the second light source 12 and the third light source 13 has the function of adjusting the quantity of emitted light.

According to the optical position detection device constructed as shown above, the transmission system 1 detects a position of the transmission system 1 relative to the reception system 2 based on the fixed distance L between the second light source 12 and the third light source 13, the incoming angle θ₂ of the signal light from the second light source 12 relative to the transmission system 1, and the incoming angle θ₃ of the signal light from the third light source 13 relative to the transmission system 1. Therefore, long-distance transmission of analog signal quantities having optical angle information, as would conventionally be involved, is no longer necessary, nor necessary is it to provide a plurality of A/D converters. Thus, there can be provided a high-accuracy optical position detection device with a low price.

Also, the reception system 2, after reception of the remote control signal light R1 derived from the first light source by the remote control light-receiving unit 16, emits signal light R2, R3 from the second light source 12 and the third light source 13. Therefore, there is no need for emitting the signal light R2, R3 normally or at specified intervals from the second light source 12 and the third light source 13, so that the position of the transmission system 1 can be detected by emitting the remote control signal light R1 at the time whenever it is desired to detect the position of the transmission system 1 (transmission operator). Thus, efficient control of the device becomes achievable.

Also, the reception system 2, after emission of the signal light R2 from the second light source 12, emits the signal light R3 from the third light source 13. Therefore, the optical angle sensor 15 of the transmission system 1 detects the signal light R2 of the second light source 12 and the signal light R3 of the third light source 13 sequentially, so that the optical angle sensor 15 can achieve angle detection by one sensor itself. Thus, the device can be made up with a low price.

Further, since the transmission system 1 and the reception system 2 are straightly confronted by each other, the angles of the transmission system 1 and the reception system 2 are fixed, so that the detection accuracy of the transmission system 1 can be improved.

Further, the transmission system 1 detects a light intensity of signal light R2 derived from the second light source 12 and a light intensity of signal light R3 derived from the third light source 13, and detects a ratio of the light intensity of the signal light R2 derived from the second light source 12 to a light intensity of signal light R3 derived from the third light source 13. Therefore, the positional information as to the transmission system 1 is supplemented with the light intensity ratio, so that the position of the transmission system 1 can be detected with high accuracy.

Also, at least either one of the second light source 12 and the third light source 13 has a function of adjusting the light emission quantity. Therefore, when the light emission quantities of the second light source 12 and the third light source 13 are controlled so that the signal light R2 of the second light source 12 and the signal light R3 of the third light source 13 to be detected by the optical angle sensor 15 become constant quantities, it becomes possible to give a supplementation to the positional information as to the transmission system 1, making it possible to detect the position of the transmission system 1 with high accuracy.

Also, the optical angle sensor 15, the second light source 12 and the third light source 13 are placed on the xz plane, and moreover the second light source 12 and the third light source 13 are placed on the x axis. Therefore, the position of the transmission system 1 can be detected with high accuracy.

According to the electronic equipment constructed as described above, since the optical position detection device is included therein, controlling the operation of the electronic equipment by the optical position detection device makes it possible to expand the application scope of the way how various types of electronic equipment are used. In the case where the electronic equipment is an air conditioner as an example, detecting a position of the remote control transmitter allows the air conditioner to perform control for indoor temperatures optimized to the position of the remote control transmitter. This makes it possible not only to provide a comfort living space but also to eliminate the need for air-conditioning wasteful spaces, by which energy saving becomes also achievable.

### Second Embodiment

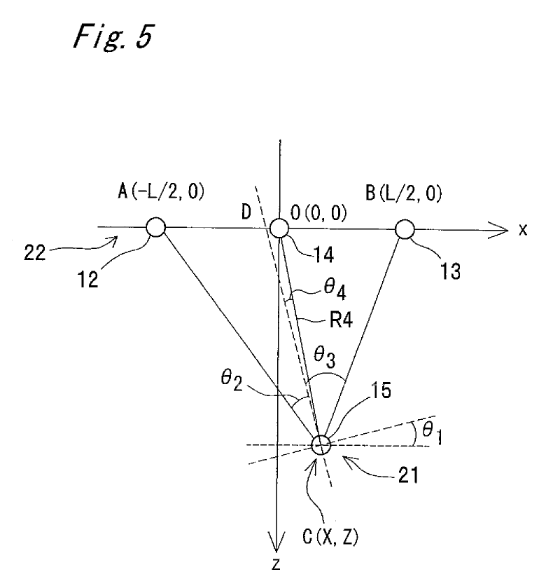

FIG. 5 shows a second embodiment of the optical position detection device of the invention. This optical position detection device differs from that of the first embodiment in that a reception system 22 has a fourth light source 14 in the second embodiment. The rest of the construction is the same as in the first embodiment and so its description is omitted.

The optical angle sensor 15 receives signal light R4 from the fourth light source 14, and detects an incoming angle (third angle θ₄) of the signal light R4 from the fourth light source 14 relative to a transmission system 21.

The reception system 22, after receiving remote control signal light derived from the first light source 11 on the remote control light-receiving unit 16 (see FIG. 1), emits signal light from the second light source 12, the third light source 13 and the fourth light source 14. That is, the reception system 22 sequentially emits signal light from the second light source 12, emits signal light from the third light source 13, and emits signal light from the fourth light source 14.

The optical angle sensor 15, the second light source 12, the third light source 13 and the fourth light source 14 are placed on the xz plane, while the second light source 12, the third light source 13 and the fourth light source 14 are placed on the x axis. The second light source 12, the third light source 13 and the fourth light source 14 are placed on the x axis at equal intervals.

FIG. 5 is a view showing the placement of the coordinate system and individual device elements, where the fourth light source 14 is placed at a position of the origin O. This embodiment is similar to the first embodiment in processes from the emission of remote control signal light from the transmission system 21 until the detection of an incident angle of the signal light from the third light source 13, but thereafter angle signal light R4 is emitted from the fourth light source 14 and an incident angle θ₄ of the angle signal light R4 from the fourth light source 14 is obtained in the optical angle sensor 15. It is noted that the incident angle θ₄ is an angle formed by the angle signal light R4 and the optical axis of the optical angle sensor 15.

In short, the optical position detection method, as shown in FIGS. 1 and 5, includes a first step for emitting remote control signal light R1 from the first light source 11, a second step for detecting the remote control signal light R1 by the remote control light-receiving unit 16, a third step for emitting angle signal light R2 from the second light source 12 based on the detected remote control signal light R1, a fourth step for detecting the angle signal light R2 by the optical angle sensor 15, a fifth step for emitting angle signal light R3 from the third light source 13 subsequent to the angle signal light R2, a sixth step for detecting the angle signal light R3 by the optical angle sensor 15, a seventh step for emitting angle signal light R4 from the fourth light source 14 subsequent to the angle signal light R3, and an eighth step for detecting the angle signal light R4 by the optical angle sensor 15.

From FIG. 5, ∠BOC results in

∠BOC=90°−θ₁+θ₄ (Equation 9)

and therefore an equation representing a line OC can be expressed as

$$\begin{matrix}z = tan ( 90 ° - {θ}_{1} + {θ}_{4} ) \cdot x \\ = \frac{- 1}{tan ( {θ}_{4} - {θ}_{1} )} \cdot x\end{matrix} \qquad ( Equation 10 )$$

Substituting coordinates (X, Z) of the point C onto the line OC and combining the equation with Equation 5 to form simultaneous equations yields the following results:

tan(θ₂+θ₁)−tan(θ₃−θ₁)+2 tan(θ₄−θ₁)=0 (Equation 11)

In the above equations, since θ₂, θ₃ and θ₄ are measured values, θ₁ is the only unknown, so that θ₁ can be obtained. Substituting the resulting values of individual θ's into Equation 5 and performing computations allows the position (X, Z) of the transmission system 21 to be detected.

Although a case in which the fourth light source 14 is placed at the origin of the coordinate system has been shown in FIG. 5, yet the position of the fourth light source 14 is not limited to this. However, when the fourth light source 14 cannot be placed at the origin due to the configuration of electronic equipment or other inconveniences and is placed at other than the origin, processes for computing the position from detected incident angles become complicated. Therefore, it is desirable that the fourth light source 14 be placed at the origin as much as possible.

According to the optical position detection device constructed as described above, the optical angle sensor 15 receives signal light R4 from the fourth light source 14 to detect an incoming angle θ₄ of the signal light R4 from the fourth light source 14 relative to the transmission system 21. Therefore, the positional information as to the transmission system 21 is supplemented with the incoming angle θ₄ of the signal light R4 from the fourth light source 14 relative to the transmission system 21, making it achievable to detect the position of the transmission system 21 with high accuracy.

Also, the reception system 22, after reception of the remote control signal light derived from the first light source 11 by the remote control light-receiving unit 16, emits signal light from the second light source 12, the third light source 13 and the fourth light source 14. Therefore, there is no need for emitting the signal light normally or at specified intervals from the second light source 12, the third light source 13 and the fourth light source 14, so that the position of the transmission system 21 can be detected by emitting the remote control signal light at the time whenever it is desired to detect the position of the transmission system 21 (transmission operator). Thus, efficient control of the device becomes achievable.

Also, since the reception system 22 sequentially emits signal light from the second light source 12, emits signal light from the third light source 13, and emits signal light from the fourth light source 14, the optical angle sensor 15 of the transmission system 21 sequentially detects the signal light of the second light source 12, the signal light of the third light source 13, and the signal light of the fourth light source 14. Thus, the optical angle sensor 15 is enabled to achieve angle detection by one sensor itself, so that the device can be made up with a low price.

Further, since the optical angle sensor 15, the second light source 12, the third light source 13 and the fourth light source 14 are placed on the xz plane while the second light source 12, the third light source 13 and the fourth light source 14 are placed on the x axis, it becomes achievable to detect the position of the transmission system 21 with high accuracy.

Further, since the second light source 12, the third light source 13 and the fourth light source 14 are placed on the x axis at equal intervals, signal-light detection accuracies of the second light source 12, the third light source 13 and the fourth light source 14 become equivalent to one another, making it possible to achieve a stable, high-accuracy position detection of the transmission system 21.

### Third Embodiment

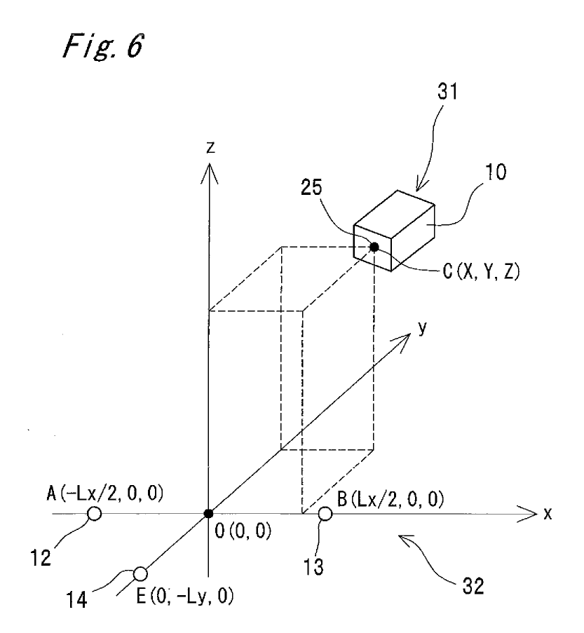

FIG. 6 shows a third embodiment of the optical position detection device of the invention. This optical position detection device differs from that of the second embodiment in that in the third embodiment, an optical angle sensor 25 is a sensor capable of detecting two-dimensional angles, while the second light source 12, the third light source 13 and the fourth light source 14 are placed on an xy plane. The rest of the construction is the same as in the second embodiment and so its description is omitted.

FIG. 6 is a view showing the placement of the coordinate system and individual device elements, where a coordinate axis y is newly added, compared with FIG. 5. The second light source 12 and the third light source 13 are placed at point A (−Lx/2,0,0) and point B (Lx/2,0,0) as in the second embodiment.

The fourth light source 14, which may be placed at any point other than on the x axis without problems in principle, is placed at a point E (0,−Ly,0) on the y axis, which is on the xy plane, for simplicity of calculations. The optical angle sensor 25 of a transmission system 31 is positioned at an arbitrary point C (X,Y,Z), and the operator, while facing toward an arbitrary direction, outputs remote control signal light from the remote control transmitter.

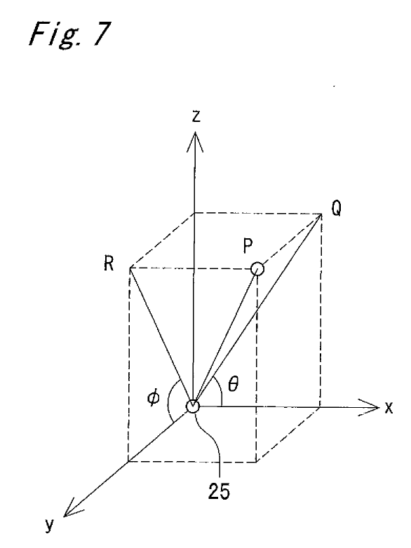

In this case, as shown in FIG. 7, on condition that the optical angle sensor 25 is positioned at the origin and that the light source is at a point P, then two angles, i.e. an angle θ of a point Q obtained by its projection onto the xz plane, and an angle φ of a point R obtained by its projection onto the yz plane, are detectable by the optical angle sensor 25.

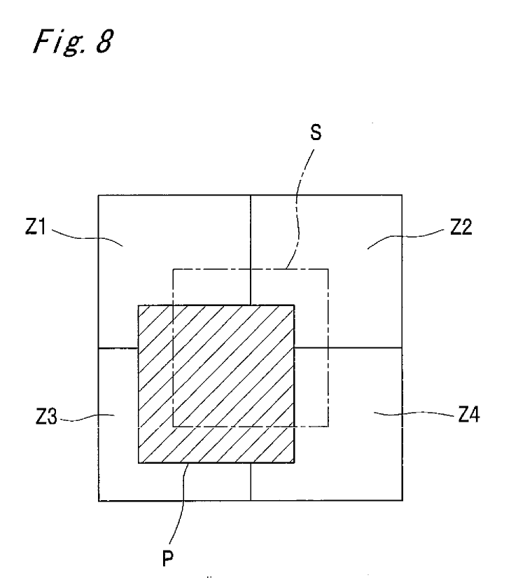

FIG. 8 shows a light-receiving element structure capable of two-dimensional angle detection as an example of the optical angle sensor 25 by referencing a prior art. As shown in FIG. 8, with an appropriate slit S (or light-shielding member) placed on the light-receiving surface, since output intensities of respective light-receiving areas Z1, Z2, Z3, Z4 vary depending on an optical spot P (or shadow), shown by hatching, formed on the light-receiving surface depending on an incident direction of light, detecting these output intensities allows such incoming angles of light as shown in FIG. 7 to be two-dimensionally detected. It is noted that in FIG. 8, light is incident in a direction of one thirty in clock time above in the drawing sheet.

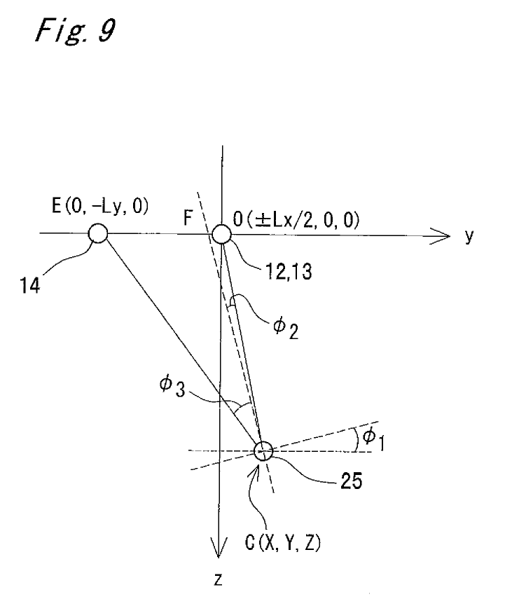

In FIG. 6, a center axis (z axis in FIG. 7) of the optical angle sensor 25 is inclined by an angle θ₁ with respect to the x axis and an angle φ₁ with respect to the y axis. In this state, projecting FIG. 6 onto the xz plane yields a result completely identical to FIG. 5, so that a position (X, Z) within the xz plane can be detected by using Equations 5 and 11. Further, projecting FIG. 6 onto the yz plane yields a result of FIG. 9. As shown in FIG. 9, the center axis of the optical angle sensor 25 is inclined by the angle φ₁ with respect to the y axis, and therefore a line OC and a line EC can be expressed as

$$Line OC \text{:} z = \frac{1}{tan ( {φ}_{1} + {φ}_{2} )} \cdot y \\ Line EC \text{:} z = \frac{1}{tan ( {φ}_{1} + {φ}_{3} )} \cdot ( y + Ly ) \qquad ( Equation 12 )$$

The x coordinate (=X) and the z coordinate (=Z) of the point C have already been detected from FIG. 5 as described above, φ₂ and φ₃ are measured values, and Ly is a known value. Therefore, substituting the Z value of Equation 5 into Equation 12 and eliminating the unknown φ₁ to reduce the equation in order yields a quadratic equation on Y as shown by Equation 13:

$$\frac{tan {φ}_{2} - tan {φ}_{3}}{{Z}^{2}} \cdot {Y}^{2} + \frac{( tan {φ}_{2} - tan {φ}_{3} ) Ly}{{Z}^{2}} \cdot Y + tan {φ}_{2} - tan {φ}_{3} + \frac{Ly}{Z} \cdot ( 1 + tan {φ}_{2} \cdot tan {φ}_{3} ) = 0 \qquad ( Equation 13 )$$

Solving this equation allows the Y coordinate to be obtained.

In the way described above, even when the transmission system 31 (optical angle sensor 25) is inclined in an arbitrary direction, its spatial position can be detected. That is, the position of the transmission system 31 relative to the reception system 32 can be detected.

### Fourth Embodiment

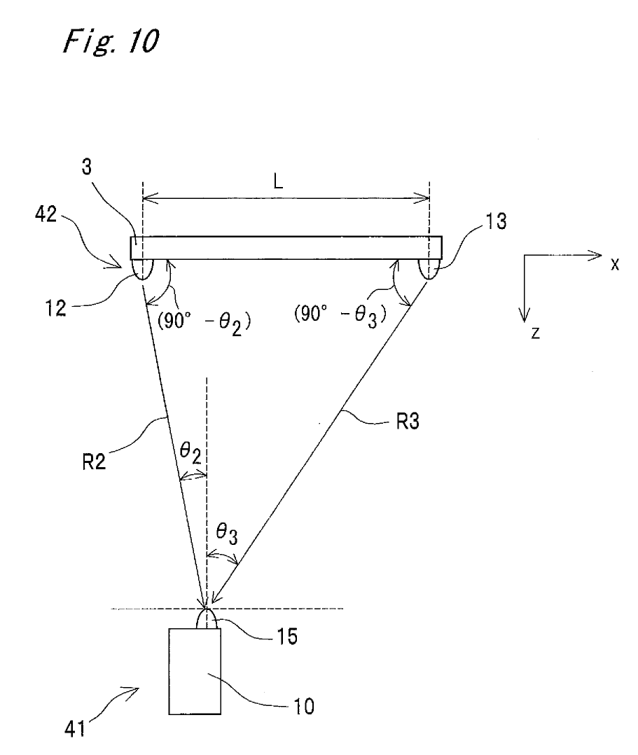

FIG. 10 shows a fourth embodiment of the optical position detection device of the invention. This optical position detection device differs from that of the first embodiment in that neither the first light source 11 nor the remote control light-receiving unit 16, both of which are included in the first embodiment (FIG. 1), are included in the fourth embodiment. The rest of the construction is the same as in the first embodiment and so its description is omitted.

The optical position detection device of this fourth embodiment has a transmission system 41 as a detection system and a reception system 42 as a reference system. The transmission system 41 has an optical angle sensor 15 for detecting an incoming angle of light. The reception system 42 has two light sources (second light source 12 and third light source 13) spaced from each other with a fixed distance.

The optical angle sensor 15 receives signal light from each of the two light sources 12, 13, and detects an incoming angle of one of the light sources (second light source 12) relative to the transmission system 41 as well as an incoming angle of the other of the light sources (third light source 13) relative to the transmission system 41.

The transmission system 41 detects a position of the transmission system 41 relative to the reception system 42 based on the fixed distance between the second light source 12 and the third light source 13, the incoming angle of the second light source 12 relative to the transmission system 41, and the incoming angle of the third light source 13 relative to the transmission system 41.

More specifically, in the first embodiment (FIG. 1), after a signal from the transmission system 1 (remote controller) is received by the reception system 2, the position of the transmission system 1 relative to the reception system 2 is detected. In contrast to this operation, in this fourth embodiment (FIG. 10), for example, the second light source 12 and the third light source 13 are made to emit light by switches or the like mounted on the electronic equipment main body 3 to measure the position of the transmission system 41 (remote controller), or the second light source 12 and the third light source 13 are made to periodically emit light to monitor position of the transmission system 41 (remote controller).

In comparison to the steps of the optical position detection method of the first embodiment (FIG. 1), this fourth embodiment has similar steps except that the fourth embodiment includes no step for emitting the remote control signal light R1 from the first light source 11 to the remote control light-receiving unit 16.

Accordingly, since the detection system detects a position of the detection system relative to the reference system based on the fixed distance between the two light sources, an incoming angle of one of the light sources relative to the detection system, and an incoming angle of the other of the light sources relative to the detection system, there is neither a need for making long-distance transmission of analog signal quantities having optical angle information nor a need for including a plurality of A/D converters, as would be involved in the prior arts, thus making it possible to provide a high-accuracy optical position detection device with a low price.

In addition, the present invention is not limited to the above-described embodiments. For example, the first to third embodiments have been described on examples of the position detection method in which the second light source 12, the third light source 13 and the fourth light source 14 are operated sequentially on the time base to thereby detect angles one by one. However, when higher-speed operations are demanded, angle signal light emitted from the second light source 12, angle signal light of the third light source 13 and angle signal light of the fourth light source 14 are modulated by frequencies different from one another so as to be emitted simultaneously. Then, providing filter circuits adapted to those modulation frequencies so as to be contained in signal processing circuits for the optical angle sensors 15, 25 makes it possible to detect the angles by separating information pieces as to the individual light sources from the received light signal in which the frequencies are mixed. Furthermore, any one of the optical position detection devices according to the first to fourth embodiments may be used for electronic equipment.

Embodiments of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical position detection device comprising:
a detection system having an optical angle sensor for detecting an incoming angle of light; and
a reference system having two light sources placed so as to be spaced from each other with a fixed distance, wherein
the optical angle sensor receives signal light from each of the two light sources to detect an incoming angle of the signal light from one of the light sources relative to the detection system as well as an incoming angle of the signal light from the other of the light sources relative to the detection system, and
the detection system detects a position of the detection system relative to the reference system based on the fixed distance between the two light sources, the incoming angle of the signal light from the one of the light sources relative to the detection system, and the incoming angle of the signal light from the other of the light sources relative to the detection system.

2. An optical position detection device comprising:
a transmission system having a first light source for emitting remote control signal light, and an optical angle sensor for detecting an incoming angle of light;
a reception system having a remote control light-receiving unit for receiving the remote control signal light from the first light source, and a second light source and a third light source placed so as to be spaced from each other with a fixed distance, wherein
the optical angle sensor receives signal lights from the second light source and the third light source to detect an incoming angle of the signal light from the second light source relative to the transmission system, and an incoming angle of the signal light from the third light source relative to the transmission system, and
the transmission system detects a position of the transmission system relative to the reception system based on the fixed distance between the second light source and the third light source, the incoming angle of the signal light from the second light source relative to the transmission system, and the incoming angle of the signal light from the third light source relative to the transmission system.

3. The optical position detection device as claimed in claim 2, wherein
the reception system receives the remote control signal light derived from the first light source on the remote control light-receiving unit, and thereafter emits the signal lights from the second light source and the third light source.

4. The optical position detection device as claimed in claim 3, wherein
the reception system emits the signal light from the second light source, and thereafter emits the signal light from the third light source.

5. The optical position detection device as claimed in claim 2, wherein
the transmission system and the reception system are straightly confronted by each other.

6. The optical position detection device as claimed in claim 2, wherein
the transmission system detects a light intensity of signal light derived from the second light source and a light intensity of signal light derived from the third light source to detect a ratio of the light intensity of signal light from the second light source to the light intensity of signal light from the third light source.

7. The optical position detection device as claimed in claim 2, wherein
at least one of the second light source and the third light source has a function of adjusting light emission quantity.

8. The optical position detection device as claimed in claim 2, wherein
the reception system has a fourth light source, and
the optical angle sensor receives signal light from the fourth light source to detect an incoming angle of the signal light from the fourth light source relative to the transmission system.

9. The optical position detection device as claimed in claim 8, wherein
the reception system receives the remote control signal light derived from the first light source on the remote control light-receiving unit, and thereafter emits signal lights from the second light source, the third light source and the fourth light source.

10. The optical position detection device as claimed in claim 9, wherein
the reception system emits signal light from the second light source, emits signal light from the third light source, and emits signal light from the fourth light source, sequentially.

11. The optical position detection device as claimed in claim 2, wherein
the optical angle sensor, the second light source and the third light source are placed on an xz plane, and
the second light source and the third light source are placed on an x axis.

12. The optical position detection device as claimed in claim 8, wherein
the optical angle sensor, the second light source, the third light source and the fourth light source are placed on an xz plane, and
the second light source, the third light source and the fourth light source are placed on an x axis.

13. The optical position detection device as claimed in claim 12, wherein
the second light source, the third light source and the fourth light source are placed on the x axis at equal intervals.

14. The optical position detection device as claimed in claim 8, wherein
the optical angle sensor is a sensor capable of detecting two-dimensional angles, and
the second light source, the third light source and the fourth light source are placed on an xy plane.

15. The optical position detection device as claimed in claim 2, wherein
signal light of the second light source and signal light of the third light source are modulated so that their modulation frequencies become different from one another.

16. The optical position detection device as claimed in claim 8, wherein
signal light of the second light source, signal light of the third light source and signal light of the fourth light source are modulated so that their modulation frequencies become different from one another.

17. Electronic equipment having the optical position detection device as defined in claim 1.
